(19) United States
(12) Patent Application Publication
(10) Pub. No.: US 2014/0358772 A1
(43) Pub. Date: Dec. 4, 2014

(54) MERCHANT AGGREGATION THROUGH MERCHANT DATA PROVISIONING

(71) Applicant: MasterCard International Incorporated, Purchase, NY (US)

(72) Inventor: Justin Xavier Howe, Oakdale, NY (US)

(21) Appl. No.: 13/909,648

(22) Filed: Jun. 4, 2013

(51) Int. Cl. G06Q 20/10

(52) U.S. Cl. CPC G06Q 20/10
USPC 705/39

(57) ABSTRACT

A method, system and machine-readable medium for aggregating merchant data from transaction data. The method includes retrieving a first data set from a data warehouse, the first data set including transaction data having a respective merchant location identifier. One or more acquiring institutions provides a data second set including merchant locations represented by the respective acquiring institution, each merchant location in the data set having an associated settlement account identifier. The first and second data sets are merged based upon common merchant locations, and merchant locations in the merged data sets having a common settlement account identifier are associated with each other.

### BACKGROUND

1. Field of the Disclosure

The present disclosure relates to electronic transaction processing. More specifically, the present disclosure is directed to method and system for compiling the transactional volume of aggregate merchants.

2. Brief Discussion of Related Art

The use of payment devices for a broad spectrum of cashless transactions has become ubiquitous in the current economy, according to some estimates accounting for hundreds of billions or even trillions of dollars in transaction volume annually. The process and parties typically involved in consummating a cashless payment transaction can be visualized for example as presented in FIG. 1, and can be thought of as a cycle, as indicated by arrow 10. A device holder 12 may present a payment device 14, for example a payment card, transponder device, NFC-enabled smart phone, among others and without limitation, to a merchant 16 as payment for goods and/or services. For simplicity the payment device 14 is depicted as a credit card, although those skilled in the art will appreciate the present disclosure is equally applicable to any cashless payment device, for example and without limitation, contactless RFID-enabled devices including smart cards, NFC-enabled smartphones, electronic mobile wallets, or the like. The payment device 14 here is emblematic of any transaction device, real or virtual, by which the device holder 12 as payor and/or the source of funds for the payment may be identified.

In cases where the merchant 16 has an established merchant account with an acquiring bank (also called the acquirer) 20, the merchant 16 communicates with the acquirer to secure payment on the transaction. An acquirer 20 is a party or entity, typically a bank, which is authorized by the network operator 22 to acquire network transactions on behalf of customers of the acquirer 20 (e.g., merchant 16). Occasionally, the merchant 16 does not have an established merchant account with an acquirer 20, but may secure payment on a transaction through a third-party payment provider 18. The third party payment provider 18 does have a merchant account with an acquirer 20, and is further authorized by the acquirer 20 and the network operator 22 to acquire payments on network transactions on behalf of sub-merchants. In this way, the merchant 16 can be authorized and able to accept the payment device 14 from a device holder 12, despite not having a merchant account with an acquirer 20.

The acquirer 20 routes the transaction request to the network operator 22. The data included in the transaction request will identify the source of funds for the transaction. With this information, the network operator 22 routes the transaction to the issuer 24. An issuer 24 is a party or entity, typically a bank, which is authorized by the network operator 22 to issue payment devices 14 on behalf of its customers (e.g., device holder 12) for use in transactions to be completed on the network. The issuer 24 also provides the funding of the transaction to the network provider 22 for transactions that it approves in the process described. The issuer 24 may approve or authorize the transaction request based on criteria such as a device holder's credit limit, account balance, or in certain instances, more detailed and particularized criteria including transaction amount, merchant classification, etc., which may optionally be determined in advance in consultation with the device holder and/or a party having financial ownership or responsibility for the account(s) funding the payment device 14, if not solely the device holder 12.

The decision by the issuer 24 to authorize or decline the transaction is routed through the network operator 22 and acquirer 20, ultimately to the merchant 16 at the point of sale. In a one-message based transaction system, the transaction is thus consummated, with payment routed between issuer 24 and acquirer 20 via the network operator. Alternately, in a two-message system, the approval of the transaction by the issuer 24 is subsequently settled or paid to the acquirer 20, who then reconciles with the merchant.

This entire process is typically carried out by electronic communication, and under routine circumstances (i.e., valid device, adequate funds, etc.) can be completed in a matter of seconds. It permits the merchant 16 to engage in transactions with a device holder 12, and the device holder 12 to partake of the benefits of cashless payment, while the merchant 16 can be assured that payment is secured. This is enabled without the need for a preexisting one-to-one relationship between the merchant 16 and every device holder 12 with whom they may engage in a transaction.

The issuer 24 may then look to its customer, e.g., device holder 12 or other party having financial ownership or responsibility for the account(s) funding the payment device 14, for payment on approved transactions, for example and without limitation, through an existing line of credit where the payment device 14 is a credit card, or from funds on deposit where the payment device 14 is a debit card. Generally, a statement document 26 provides information on the account of a device holder 12, including merchant data as provided by the acquirer 20 via the network operator 22.

The network operator 22 can further build and maintain a data warehouse that stores and augments transaction data for use in marketing, macroeconomic reporting, etc. To this end, transaction data from multiple transactions is aggregated for reporting purposes according to a location of the merchant 16. Additionally, one merchant 16 may operate plural card acceptance locations. Consider, for example, a chain or franchise having multiple business locations. These merchant locations are beneficially aggregated and assigned an aggregate merchant location identifier for reporting purposes.

Of all the data handled in the transaction process, the merchant's data tends to be the least stable and most difficult to deal with. One of the challenges with merchant data is the fact that there is no universal merchant location identifier. Rather, the network operator 22 must build and maintain the data warehouse itself, derived from merchant data included in the transaction data delivered via the acquirer 20. Similarly, there is no reliable location identifier in the data received that indicates if a merchant location belongs to a chain or not, for example for aggregation purposes. Again, the network operator 22 augments transactions with this information, based on the received merchant name, the acquiring bank, and several other fields. The process of grouping merchant locations into sets of chain merchants is called “merchant aggregation” and maintaining the integrity of these aggregations is a challenge. Ultimately, the network operator 22 must rely on imperfect inference from the transaction data to perform its merchant aggregation.

Merchants 16 and acquirers 20 do not consistently or predictably submit their data in the same way, thus creating the need to monitor the integrity of this data. Merchants 16 can change acquirers 20; they open and close locations; they rebrand themselves—just to name a few of the challenges. When any of these or other changes to merchant data happen, the rules used to assign an identifier to a merchant location and/or associate that merchant location with an aggregate merchant location identifier often fail. Even cursory human oversight of each and every merchant location would be prohibitively expensive considering the total number of merchants 16 accepting authorized payment devices 14, or even that subset of aggregate merchants whom the network operator 22 wishes to monitor.

Existing merchant aggregation efforts rely on text matching, address recognition, or even feedback from the merchant to properly group and/or classify merchants in the aggregate. However, no method to date can assure that every eligible merchant location is contained within the aggregate. Furthermore, a merchant point-of-sale (POS) terminal can be resold or transferred among merchants. If the POS terminal is not rebuilt properly before redistributing to a different merchant, techniques that look to the POS terminal identification data to aid in the aggregation may result in inaccuracies. Likewise, an unreputable merchant who intentionally selected their name so as to be mistaken for a different entity would be prone to misaggregation. A solution to this aggregate merchant data quality deficit problem remains wanting.

### SUMMARY

The instant application describes a solution to the problem of aggregate merchant data quality deficit.

Among the problems influencing the merchant data quality deficit is that, in the example of the largest merchants, they may use more than one acquirer 20 to process all of their transaction volume across their entire chain of stores. This may or may not be divided by merchant subsidiary, and may be without regard to plural transaction device 14 acceptance terminals at a given location. Each acquirer may have a different data format for merchant name and location. In some cases, multiple terminals, even those processed through the same acquirer 20 and in the same location of a given merchant 16, may have variations in data presentation. Franchise chain data can be particularly troublesome, as the merchant is generally an independent entity, although the value in data reporting is to be found in aggregating transactions under the franchise umbrella.

On the other hand, the acquirer 20 has perfect knowledge of any and all of its merchant 16 clients and the identity of each of their terminals, in order to accurately credit payments from processed transactions. However, it is generally not feasible for the acquirer 20 to provide this information to the network operator 22 for each and every transaction, at least in part due to the massive volume of data on a daily basis that such a transfer represents.

Therefore, provided according to the present disclosure is a method of aggregating merchant data from transaction data, which method includes retrieving a first data set from a data warehouse, the first data set including transaction data having a respective merchant location identifier. One or more acquiring institutions provides a data second set including merchant locations represented by the respective acquiring institution, each merchant location in the data set having an associated settlement account identifier. The first and second data sets are merged based upon common merchant locations, and merchant locations in the merged data sets having a common settlement account identifier are associated with each other.

In a further embodiment of the presently disclosed method, the association of merchant locations having a common settlement account identifier is recorded in the data warehouse. Optionally or additionally, associating merchant locations having a common settlement account identifier comprises assigning the merchant locations to a common aggregate merchant location identifier, and/or creating an aggregate merchant location identifier and applying the created aggregate merchant location identifier responsive to one or more merchant locations having a common settlement account identifier and neither merchant location being associated with an aggregate merchant location identifier.

In a further embodiment of the presently disclosed method, for each of plural acquirers, the receiving, merging and associating operations are performed iteratively. Optionally, the second data set received from the one or more acquiring institutions includes a representative transactions from each terminal for which it acquires payments, each representative transaction being associated with an identification of the merchant location using that terminal.

Further provided according to the instant disclosure is a system for aggregating merchant data from transaction data, which system includes a processor and a non-transitory machine-readable recording medium storing thereon a program of instruction which, when executed by the processor, cause the processor to execute the foregoing described method in any or all of its embodiments. Further provided according to the instant disclosure is a non-transitory machine-readable recording medium storing such a program of instruction thereon.

These and other purposes, goals and advantages of the present disclosure will become apparent from the following detailed description of example embodiments read in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 illustrates schematically the process and parties typically involved in consummating a cashless payment transaction;

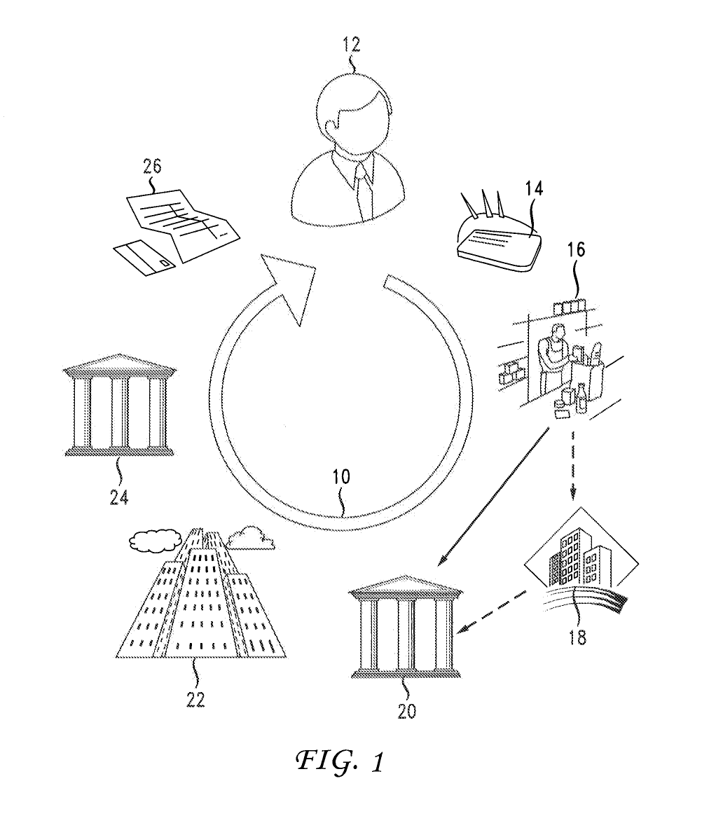

FIG. 2 illustrates a flowchart for aggregating merchant data from transaction data according to the presently disclosed methods; and

FIG. 3 illustrates schematically a representative computer according to the present disclosure, operative to implement the disclosed methods.

### DETAILED DESCRIPTION

All extant merchant aggregation methods are based upon the assumption that it is more efficient to infer the parent merchant from information in the authorization or clearing data stream, or with third-party data providers (e.g., yellow pages, Nielsen, etc.) than to obtain acquirer settlement data that is unknown to the payment network. The present disclosure provides a method of instead using acquirer-provided billing information to identify all eligible locations for a particular aggregation or classification, while excluding ineligible locations.

Present techniques permit a network operator 22 to infer a certain level of aggregation for a given set of merchant locations. Consider for example the following Table 1. Each merchant location is associated with an acquirer 20 (e.g., Acquirer 1, Acquirer 2, or Acquirer 3). It is noted that each merchant location further has its own unique key which is not shown in the table. Some of those merchant locations are further associated with a respective aggregate merchant, a subsidiary, and a parent or holding company. It will be readily apparent, however, that the network operator 22 data set is incomplete. Certain merchant locations are blank and/or unknown. Still others are omitted from their appropriate aggregation, e.g., Gap Kids® location Nos. 1-3, and Old Navy® location No. 4. It should be noted that the particular merchants and holding companies recited herein are archetypes only, and no affiliation with, endorsement by, or interest in, or to, those entities should be inferred.

TABLE 1

| Acquirer | Merchant Location | Aggregate Merchant | Subsidiary | Holding Company |
|---|---|---|---|---|
| Acquirer 1 | Gap #1 | Gap | Gap | Gap Inc. |
| Acquirer 1 | Gap #2 | Gap | Gap | Gap Inc. |
| Acquirer 1 | Gap #3 | Gap | Gap | Gap Inc. |
| Acquirer 1 | Old Navy #1 | Old Navy | Old Navy | Gap Inc. |
| Acquirer 1 | Old Navy #2 | Old Navy | Old Navy | Gap Inc. |
| Acquirer 1 | Old Navy #3 | Old Navy | Old Navy | Gap Inc. |
| Acquirer 1 | Banana Republic #1 | Banana Republic | Banana Republic | Gap Inc. |
| Acquirer 1 | Banana Republic #2 | Banana Republic | Banana Republic | Gap Inc. |
| Acquirer 1 | Banana Republic #3 | Banana Republic | Banana Republic | Gap Inc. |
| Acquirer 2 | Gap.com | Gap.com | Gap | Gap Inc. |
| Acquirer 2 | OldNavy.com | OldNavy.com | Old Navy | Gap Inc. |
| Acquirer 2 | BananaRepublic.com | BananaRepublic.com | Banana Republic | Gap Inc. |
| Acquirer 3 | Unknown Location 1 | — | — | — |
| Acquirer 3 | Unknown Location 2 | — | — | — |
| Acquirer 1 | Blank Location 1 | — | — | — |
| Acquirer 1 | Blank Location 2 | — | — | — |
| Acquirer 1 | Gap Kids #1 | — | — | — |
| Acquirer 1 | Gap Kids #2 | — | — | — |
| Acquirer 1 | Gap Kids #3 | — | — | — |
| Acquirer 1 | Old Navy #4 | — | — | — |

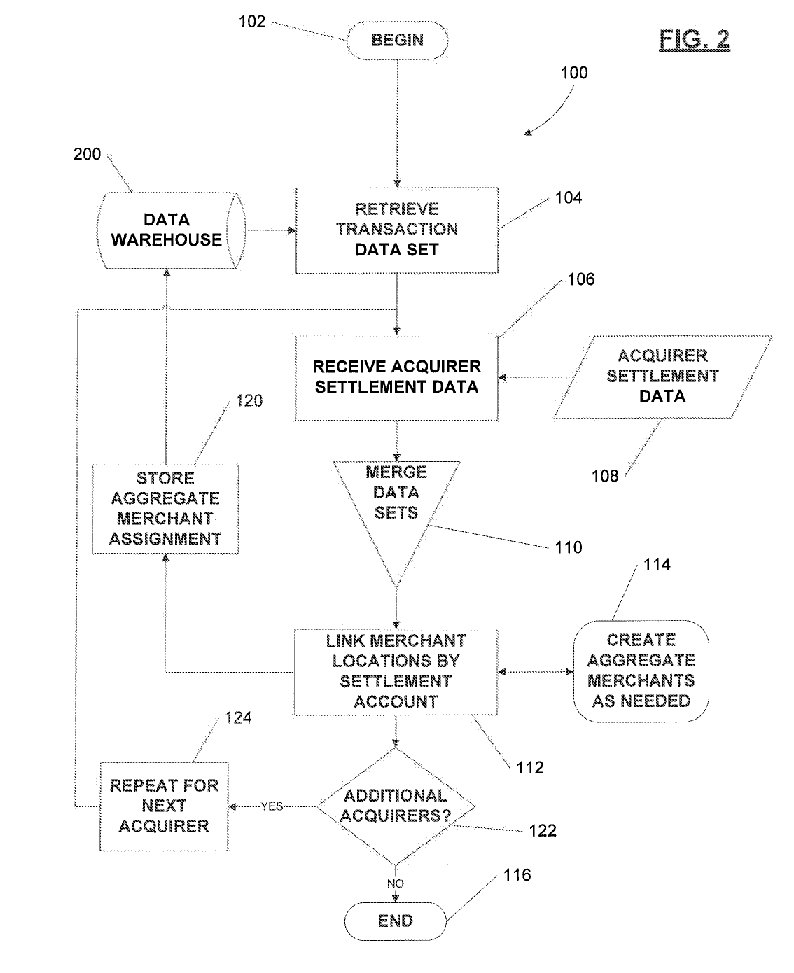

The merchant aggregation process of the present disclosure can be described as proceeding according to the flowchart, generally 100, depicted in FIG. 2. The process begins at 102. A transaction data set is retrieved 104 from the network operator's data warehouse 200. The transaction data, and the merchant data integral thereto, is the source from which a table such as Table 1 is populated. The raw transaction data can be augmented by inferences, e.g., textural similarity in the name or street address fields, and/or third-party provided data (yellow pages, etc.) as described above.

According to the present disclosure, one or more acquirers 20 will provide to the network operator 22 information (e.g., a database table) correlating each merchant location for which it receives payments, and a settlement account to which those payments are made. The settlement account information may include the actual settlement account particulars. However, for the purposes of the presently disclosed method the settlement account information need only include a unique identifier of the payee for each given merchant location. This is depicted in the flowchart 100 as receiving acquirer settlement data 106, which settlement data is depicted at 108.

The following is an example of such a correlation table for fictive Acquirer 1. This information identifies all of the locations and the respective bank accounts into which the funds the acquirer is to pay each merchant location will be placed. Accordingly, every merchant that deposits into the same account has a financial relationship, presumptively being members of the same holding company.

TABLE 2
Settlement

| Acquirer | Merchant Location | Account |
|---|---|---|
| Acquirer 1 | Gap #1 | Account #1 |
| Acquirer 1 | Gap #2 | Account #1 |
| Acquirer 1 | Gap #3 | Account #1 |
| Acquirer 1 | Old Navy #1 | Account #1 |
| Acquirer 1 | Old Navy #2 | Account #1 |
| Acquirer 1 | Old Navy #3 | Account #1 |
| Acquirer 1 | Banana Republic #1 | Account #1 |
| Acquirer 1 | Banana Republic #2 | Account #1 |
| Acquirer 1 | Banana Republic #3 | Account #1 |
| Acquirer 1 | Blank Location 1 | Account #1 |
| Acquirer 1 | Blank Location 2 | Account #1 |
| Acquirer 1 | Gap Kids #1 | Account #1 |
| Acquirer 1 | Gap Kids #2 | Account #1 |
| Acquirer 1 | Gap Kids #3 | Account #1 |
| Acquirer 1 | Old Navy #4 | Account #1 |
| Acquirer 1 | Kroger #1 | Account #2 |
| Acquirer 1 | Kroger #2 | Account #2 |
| Acquirer 1 | McDonald's #1 | Account #3 |
| Acquirer 1 | McDonald's #2 | Account #3 |
| Acquirer 1 | McDonald's #3 | Account #3 |

The two datasets are merged with one another, using the merchant location as the key field. The merger of the two datasets is depicted at operation 110 of the flowchart 100 in FIG. 2. Any merchant locations using the same settlement account are added to the aggregation under the holding company associated with that account. For example, from the merged data of Table 2, it can be seen that there is a clear financial relationship between Gap®, Inc. and Blank Location Nos. 1 & 2, Gap Kids® Nos. 1-3, and Old Navy® No. 4. Accordingly, the network operator could revise its aggregation table to reflect these merchant locations' association with the holding company. This revision is reflected in Table 3, below. The operation to link merchant locations by settlement account 112 is depicted in FIG. 2. The network operator can further store the new aggregate merchant assignments, operation 120, to its data warehouse 200.

TABLE 3

| | | | | Holding | |
|---|---|---|---|---|---|
| Acquirer | Merchant Location | Account | Subsidiary | Company | Account |
| Acquirer 1 | Gap #1 | Gap | Gap | Gap Inc. | Acct #1 |
| Acquirer 1 | Gap #2 | Gap | Gap | Gap Inc. | Acct #1 |
| Acquirer 1 | Gap #3 | Gap | Gap | Gap Inc. | Acct #1 |
| Acquirer 1 | Old Navy #1 | Old Navy | Old Navy | Gap Inc. | Acct #1 |
| Acquirer 1 | Old Navy #2 | Old Navy | Old Navy | Gap Inc. | Acct #1 |
| Acquirer 1 | Old Navy #3 | Old Navy | Old Navy | Gap Inc. | Acct #1 |
| Acquirer 1 | Banana Republic #1 | Banana Republic | Banana Republic | Gap Inc. | Acct #1 |
| Acquirer 1 | Banana Republic #2 | Banana Republic | Banana Republic | Gap Inc. | Acct #1 |
| Acquirer 1 | Banana Republic #3 | Banana Republic | Banana Republic | Gap Inc. | Acct #1 |
| Acquirer 2 | Gap.com | Gap.com | Gap | Gap Inc. | — |
| Acquirer 2 | OldNavy.com | OldNavy.com | Old Navy | Gap Inc. | — |
| Acquirer 2 | BananaRepublic.com | BananaRepublic.com | Banana Republic | Gap Inc. | — |
| Acquirer 3 | Unknown Location 1 | — | — | — | — |
| Acquirer 3 | Unknown Location 2 | — | — | — | — |
| Acquirer 1 | Blank Location 1 | — | — | — | Acct #1 |
| Acquirer 1 | Blank Location 2 | — | — | — | Acct #1 |
| Acquirer 1 | Gap Kids #1 | — | — | — | Acct #1 |
| Acquirer 1 | Gap Kids #2 | — | — | — | Acct #1 |
| Acquirer 1 | Gap Kids #3 | — | — | — | Acct #1 |
| Acquirer 1 | OldNavy #4 | — | — | — | Acct #1 |
| Acquirer 1 | Kroger #1 | — | — | — | Acct #2 |
| Acquirer 1 | Kroger #2 | — | — | — | Acct #2 |
| Acquirer 1 | McDonald's #1 | — | — | — | Acct #3 |
| Acquirer 1 | McDonald's #2 | — | — | — | Acct #3 |
| Acquirer 1 | McDonald's #3 | — | — | — | Acct #3 |

Furthermore, any merchant locations using the same settlement account without a known holding company can be assigned to their own presumptive holding company. For example, two other holding companies can be identified from this merged dataset, by looking at the ‘Account #2’ and ‘Account #3’ data. More specifically, a Kroger® Holding company can be created and a McDonald's® Holding Company can be created, based upon the plural respective Kroger and McDonald's merchant locations sharing settlement accounts. This is depicted in FIG. 2 as operation 114.

Accordingly the data set augmented in this way can be seen in Table 4, below.

TABLE 4

| | | | | Holding | |
|---|---|---|---|---|---|
| Acquirer | Merchant Location | Account | Subsidiary | Company | Account |
| Acquirer 1 | Gap #1 | Gap | Gap | Gap Inc. | Acct #1 |
| Acquirer 1 | Gap #2 | Gap | Gap | Gap Inc. | Acct #1 |
| Acquirer 1 | Gap #3 | Gap | Gap | Gap Inc. | Acct #1 |
| Acquirer 1 | Old Navy #1 | Old Navy | Old Navy | Gap Inc. | Acct #1 |
| Acquirer 1 | Old Navy #2 | Old Navy | Old Navy | Gap Inc. | Acct #1 |
| Acquirer 1 | Old Navy #3 | Old Navy | Old Navy | Gap Inc. | Acct #1 |
| Acquirer 1 | Banana Republic #1 | Banana Republic | Banana Republic | Gap Inc. | Acct #1 |
| Acquirer 1 | Banana Republic #2 | Banana Republic | Banana Republic | Gap Inc. | Acct #1 |
| Acquirer 1 | Banana Republic #3 | Banana Republic | Banana Republic | Gap Inc. | Acct #1 |
| Acquirer 2 | Gap.com | Gap.com | Gap | Gap Inc. | — |
| Acquirer 2 | OldNavy.com | OldNavy.com | Old Navy | Gap Inc. | — |
| Acquirer 2 | BananaRepublic.com | BananaRepublic.com | Banana Republic | Gap Inc. | — |
| Acquirer 3 | Unknown Location 1 | — | — | — | — |
| Acquirer 3 | Unknown Location 2 | — | — | — | — |
| Acquirer 1 | Blank Location 1 | — | — | Gap Inc. | Acct #1 |
| Acquirer 1 | Blank Location 2 | — | — | Gap Inc. | Acct #1 |
| Acquirer 1 | Gap Kids #1 | — | — | Gap Inc. | Acct #1 |
| Acquirer 1 | Gap Kids #2 | — | — | Gap Inc. | Acct #1 |
| Acquirer 1 | Gap Kids #3 | — | — | Gap Inc. | Acct #1 |
| Acquirer 1 | Old Navy #4 | — | — | Gap Inc. | Acct #1 |
| Acquirer 1 | Kroger #1 | — | — | Kroger Inc. | Acct #2 |
| Acquirer 1 | Kroger #2 | — | — | Kroger Inc. | Acct #2 |
| Acquirer 1 | McDonald's #1 | — | — | McDonald's | Acct #3 |
| | | | | Inc. | |
| Acquirer 1 | McDonald's #2 | — | — | McDonald's | Acct #3 |
| | | | | Inc. | |
| Acquirer 1 | McDonald's #3 | — | — | McDonald's | Acct #3 |
| | | | | Inc. | |

Once the accounts have been linked by holding company, the existing Subsidiary is applied to categorize merchant locations belonging to the same company (i.e. Old Navy® #4 is Subsidiary=‘Old Navy’). Alternately or additionally, textual clustering can be used to identify similarly named locations (e.g., Gap Kids®). Such text matching techniques are disclosed, for example in U.S. Patent Application Publication No. 2009/0171759 by McGeehan, which is commonly assigned with the instant application and is incorporated herein by reference. Additional known techniques of incorporating third-party data information may be employed here as well. This additional level of augmentation is seen below in Table 5.

TABLE 5

| | | | | Holding | |
|---|---|---|---|---|---|
| Acquirer | Merchant Location | Account | Subsidiary | Company | Account |
| Acquirer 1 | Gap #1 | Gap | Gap | Gap Inc. | Acct #1 |
| Acquirer 1 | Gap #2 | Gap | Gap | Gap Inc. | Acct #1 |
| Acquirer 1 | Gap #3 | Gap | Gap | Gap Inc. | Acct #1 |
| Acquirer 1 | Old Navy #1 | Old Navy | Old Navy | Gap Inc. | Acct #1 |
| Acquirer 1 | Old Navy #2 | Old Navy | Old Navy | Gap Inc. | Acct #1 |
| Acquirer 1 | Old Navy #3 | Old Navy | Old Navy | Gap Inc. | Acct #1 |
| Acquirer 1 | Banana Republic #1 | Banana Republic | Banana Republic | Gap Inc. | Acct #1 |
| Acquirer 1 | Banana Republic #2 | Banana Republic | Banana Republic | Gap Inc. | Acct #1 |
| Acquirer 1 | Banana Republic #3 | Banana Republic | Banana Republic | Gap Inc. | Acct #1 |
| Acquirer 2 | Gap.com | Gap.com | Gap | Gap Inc. | — |
| Acquirer 2 | OldNavy.com | OldNavy.com | Old Navy | Gap Inc. | — |
| Acquirer 2 | BananaRepublic.com | BananaRepublic.com | Banana Republic | Gap Inc. | — |
| Acquirer 3 | Unknown Location 1 | — | — | — | — |
| Acquirer 3 | Unknown Location 2 | — | — | — | — |
| Acquirer 1 | Blank Location 1 | Gap Unknown | Gap Unknown | Gap Inc. | Acct #1 |
| Acquirer 1 | Blank Location 2 | Gap Unknown | Gap Unknown | Gap Inc. | Acct #1 |
| Acquirer 1 | Gap Kids #1 | Gap Kids | Gap Kids | Gap Inc. | Acct #1 |
| Acquirer 1 | Gap Kids #2 | Gap Kids | Gap Kids | Gap Inc. | Acct #1 |
| Acquirer 1 | Gap Kids #3 | Gap Kids | Gap Kids | Gap Inc. | Acct #1 |
| Acquirer 1 | Old Navy #4 | Old Navy | Old Navy | Gap Inc. | Acct #1 |
| Acquirer 1 | Kroger #1 | Kroger | Kroger | Kroger Inc. | Acct #2 |
| Acquirer 1 | Kroger #2 | Kroger | Kroger | Kroger Inc. | Acct #2 |
| Acquirer 1 | McDonald's #1 | McDonald's | McDonald's | McDonald's Inc. | Acct #3 |
| Acquirer 1 | McDonald's #2 | McDonald's | McDonald's | McDonald's Inc. | Acct #3 |
| Acquirer 1 | McDonald's #3 | McDonald's | McDonald's | McDonald's Inc. | Acct #3 |

From Table 5, aggregation information pertaining to all merchant locations having an aggregate pay-to account as derived from the acquirer's 20 payment account information has been populated. If there are additional acquirers 20 from which to receive settlement data, decision 122, then the process is repeated at 124 for a next acquirer 20. The method proceeds with the application of data from a subsequent acquirer 20, i.e., Acquirer No. 2 and Acquirer No. 3 in the present example. It should be noted that when a holding company uses separate acquirers who pay to a common settlement account, the association between merchant locations serviced by different acquirers 20 can be identified across the multiple acquirers. If there are no further acquirers 20 from whom to receive data, the process is ended 116. Generally the entire process is repeated periodically, e.g., daily, weekly, etc., as needed to keep pace with shifting merchant data.

Referring again to the acquirer-provided (or provisioned) data set, i.e., Table 2, it is possible for the acquirer 20 to provide information to the network operator 22 other than the settlement account data or and identifier for the settlement account, from which the aggregation association could be made. Alternately or additionally, the present disclosure also contemplates having the acquirer 20 identify to the network operator 22 on a routine and periodic basis (i.e., daily) at least one, but in the aggregate no more than a manageable number, of a representative transactions from each and every terminal for which it acquires payments. The representative transaction will be associated by the acquirer 20 with a standardized and mutually recognizable identification of the merchant and location associated with that terminal. From this information, the network operator 22 may associate each individual terminal with its corresponding aggregate merchant to a high degree of accuracy.

It will be appreciated by those skilled in the art that the method described above may be operated by a machine operator having a suitable interface mechanism, and/or more typically in an automated manner, for example by operation of a network-enabled computer system, including a processor executing a system of instructions stored on a machine-readable medium, RAM, hard disk drive, or the like. The instructions will cause the processor to operate in accordance with the present disclosure.

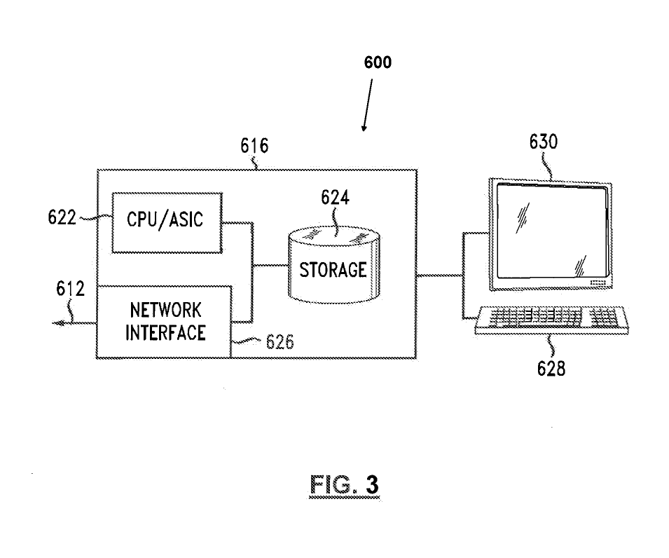

Turning then to FIG. 3, illustrated schematically is a representative computer 616 of the system 600. The computer 616 includes at least a processor or CPU 622 that is operative to act on a program of instructions stored on a computer-readable medium 624. Execution of the program of instruction causes the processor 622 to carry out, for example, the methods described above according to the various embodiments. It may further or alternately be the case that the processor 622 comprises application-specific circuitry including the operative capability to execute the prescribed operations integrated therein. The computer 616 will in many cases includes a network interface 626 for communication with an external network 612. Optionally or additionally, a data entry device $28 (e.g., keyboard, mouse, trackball, pointer, etc) facilitates human interaction with the server, as does an optional display 630. In other embodiments, the display 630 and data entry device 628 are integrated, for example a touch-screen display having a graphic user interface (GUI).

Variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

I/We claim:

1. A method of aggregating merchant data from transaction data, the method comprising:
retrieving a first data set from a data warehouse, the first data set including transaction data having a merchant location identifier;
receiving, from one or more acquiring institutions, a second data set including merchant locations represented by the respective acquiring institution, each merchant location in the data set having an associated settlement account identifier;
merging the first and second data sets based upon common merchant locations; and
associating merchant locations in the merged data sets having a common settlement account identifier.

2. The method according to claim 1, further comprising recording the association of merchant locations having a common settlement account identifier in the data warehouse.

3. The method according to claim 1, wherein associating merchant locations having a common settlement account identifier comprises assigning the merchant locations to a common aggregate merchant location identifier.

4. The method according to claim 1, further comprising creating an aggregate merchant location identifier and applying the created aggregate merchant location identifier responsive to one or more merchant locations having a common settlement account identifier and neither merchant location being associated with an aggregate merchant location identifier.

5. The method according to claim 1, further comprising, for each of plural acquirers, iteratively repeating the receiving, merging and associating operations.

6. The method according to claim 1, wherein the second data set received from the one or more acquiring institutions includes a representative transaction from each terminal for which it acquires payments, each representative transaction being associated with an identification of the merchant location using that terminal.

7. A system for aggregating merchant data from transaction data, the system comprising:
a processor; and
a non-transitory machine-readable recording medium storing thereon a program of instruction which, when executed by the processor, cause the processor to:
retrieve a first data set from a data warehouse, the first data set including transaction data having a merchant location identifier;
receive, from one or more acquiring institutions, a second data set including merchant locations represented by the respective acquiring institution, each merchant location in the data set having an associated settlement account identifier;
merge the first and second data sets based upon common merchant locations; and
associate merchant locations in the merged data sets having a common settlement account identifier.

8. The system according to claim 7, wherein the program of instruction further causes the processor to record the association of merchant locations having a common settlement account identifier in the data warehouse.

9. The system according to claim 7, wherein the instruction to associate merchant locations having a common settlement account identifier comprises an instruction to assign the merchant locations to a common aggregate merchant location identifier.

10. The system according to claim 1, wherein the program of instruction further causes the processor to create an aggregate merchant location identifier and apply the created aggregate merchant location identifier responsive to one or more merchant locations having a common settlement account identifier and neither merchant location being associated with an aggregate merchant location identifier.

11. The system according to claim 7, wherein the program of instruction further causes the processor to, for each of plural acquirers, iteratively repeat the receiving, merging and associating operations.

12. The system according to claim 7, wherein the second data set received from the one or more acquiring institutions includes a representative transaction from each terminal for which it acquires payments, each representative transaction being associated with an identification of the merchant location using that terminal.

13. A non-transitory machine-readable recording medium storing thereon a program of instruction which, when executed by a processor, cause the processor to:
retrieve a first data set from a data warehouse, the first data set including transaction data having a merchant location identifier;
receive, from one or more acquiring institutions, a second data set including merchant locations represented by the respective acquiring institution, each merchant location in the data set having an associated settlement account identifier;
merge the first and second data sets based upon common merchant locations; and
associate merchant locations in the merged data sets having a common settlement account identifier.

14. The medium according to claim 13, wherein the program of instruction further causes the processor to record the association of merchant locations having a common settlement account identifier in the data warehouse.

15. The medium according to claim 13, wherein the instruction to associate merchant locations having a common settlement account identifier comprises an instruction to assign the merchant locations to a common aggregate merchant location identifier.

16. The medium according to claim 13, wherein the program of instruction further causes the processor to create an aggregate merchant location identifier and apply the created aggregate merchant location identifier responsive to one or more merchant locations having a common settlement account identifier and neither merchant location being associated with an aggregate merchant location identifier.

17. The medium according to claim 13, wherein the program of instruction further causes the processor to, for each of plural acquirers, iteratively repeat the receiving, merging and associating operations.

18. The medium according to claim 13, wherein the second data set received from the one or more acquiring institutions includes a representative transaction from each terminal for which it acquires payments, each representative transaction being associated with an identification of the merchant location using that terminal.
